(19) United States
(12) Patent Application Publication
(10) Pub. No.: US 2006/0260648 A1
(43) Pub. Date: Nov. 23, 2006

(54) Apparatus and method of automatically cleaning a pick-up head

(75) Inventors: Diann-Fang Lin, Hsin-Chu City (TW); Hsin Hui Han, Hsin-Chu City (TW)

Correspondence Address: BIRCH STEWART KOLASCH & BIRCH, PO BOX 747, FALLS CHURCH, VA, 22040-0747, US

(73) Assignee: King Yuan Electronics Co., Ltd.

(21) Appl. No.: 11/197,441

(22) Filed: Aug. 5, 2005

(30) Foreign Application Priority Data
May 13, 2005 (TW) 94115571

(51) Int. Cl. B08B 7/00; C23G 1/00; B08B 3/00

(52) U.S. Cl. 134/6; 134/2; 134/137

(57) ABSTRACT

Apparatus and method of automatically cleaning a pick-up head is disclosed. After picking up and placing down the dies many times, the pick-up head is placed on a glue-tape to attract contaminants, thereby automatically cleaning the pick-up head and preventing the dies from being damaged.

### BACKGROUND OF THE INVENTION

1. Field of the Invention

The present invention generally relates to apparatus and method of automatically cleaning a pick-up head, and more particularly to a pick-and-place apparatus capable of automatically cleaning its pick-up head.

2. Description of the Prior Art

A manufactured wafer is sawed or diced into dies/chips, which are then respectively under packaging and test, concluding fabricating the integrated circuits.

Due to the small size of the die/chip, it is mostly picked by a pick-up head in an automation manner to prevent it from being damaged or cracked. For example, a pick-up head is utilized in a pick-and-place apparatus. As a further example, a pick-up head is also used to pick a die and attach it to a substrate in an integrated circuit (IC) packaging process.

FIG. 1A and FIG. 1B illustrate a conventional pick-up head, which includes a sucker 1A and a vacuum channel 1C. To the top of the sucker 1A is a drawing surface 1D and a hole 1E, which connects with an opening 1B and finally to the vacuum channel 1C. After the sucker 1A contacts a die 13, the vacuum in the vacuum channel 1C of the pick-up head thus picks up the die 13.

FIG. 2A to FIG. 2C illustrate the flow of picking a die and placing it unto a tray. A wafer 21 is placed on a supporting table 24, and the pick-up head 23 moves, under the control of a robot 28, over the wafer 21. Subsequently, the pick-up head 23 picks one die 26 to a receiving groove 20 of the tray 22, which is disposed on a tray stand 25.

FIG. 2A shows the moment that the die 26 is picked by the pick-up head 23, and FIG. 2B shows that the robot 28 lifts the pick-up head 23, which carries the die 26 towards the tray 22. In FIG. 2C, the robot 28 lowers the pick-up head 23, and the pick-up head 23 releases the vacuum and disengages the die 26 unto the groove 20.

The pick-up head in the conventional process is prone to contamination such as the particulate generated in sawing the wafer into dies/chips. The particulate is easily to be attached to the tip of the pick-up head, and may damage the wafer or even the pick-up head itself. Accordingly, the pick-and-place apparatus needs to be periodically shut down in order to clean (in an ultrasonic cleaner, for example) or replace the pick-up head, in order to prevent the particulate from contaminating the pick-up head. Shutting down the apparatus wastes time and manpower, and greatly reduces the equipment efficiency and productivity. Further, cleaning and replacing the pick-up head cost a lot. For the above reason, a need has arisen to reduce the contamination to the pick-up head, to increase the IC yield, and to enhance the equipment efficiency and productivity.

### SUMMARY OF THE INVENTION

In view of the foregoing, it is an object of the present invention to provide the apparatus and method of automatically cleaning a pick-up head, in order to reduce the contamination to the pick-up head, to increase the IC yield, and to enhance the equipment efficiency and productivity.

According to the object, the present invention provides apparatus and method of automatically cleaning a pick-up head. According to one embodiment, after picking up and placing down the dies many times, the pick-up head is placed on a glue-tape to attract contaminants, thereby automatically cleaning the pick-up head and preventing the dies from being damaged.

### BRIEF DESCRIPTION OF THE DRAWINGS

FIG. 1A and FIG. 1B illustrate a conventional pick-up head;

FIG. 2A to FIG. 2C illustrate the flow of picking a die and placing it unto a tray in the prior art, wherein:

FIG. 2A shows the moment that a die is picked by the pick-up head;

FIG. 2B shows that the robot lifts the pick-up head, which carries the die towards the tray;

FIG. 2C shows that the robot lowers the pick-up head, and the pick-up head releases the vacuum and disengages the die unto the groove; and

FIG. 3A to FIG. 3E illustrate the primary flow of automatically cleaning a pick-up head according to one embodiment of the present invention, wherein:

FIG. 3A shows the moment that a die is picked by the pick-up head;

FIG. 3B shows that the robot lifts the pick-up head, which carries the die towards the tray;

FIG. 3C shows that the robot lowers the pick-up head, and the pick-up head releases the vacuum and disengages the die unto the groove;

FIG. 3D shows that the robot moves the pick-up head towards the glue-tape, and the tip of the pick-up head contacts the glue-tape for at least one time;

FIG. 3E shows that the robot lifts the pick-up head and moves towards the wafer.

### DETAILED DESCRIPTION OF THE INVENTION

The detailed description of the present invention will be discussed in the following embodiments, which are not intended to limit the scope of the present invention, but can be adapted for other applications.

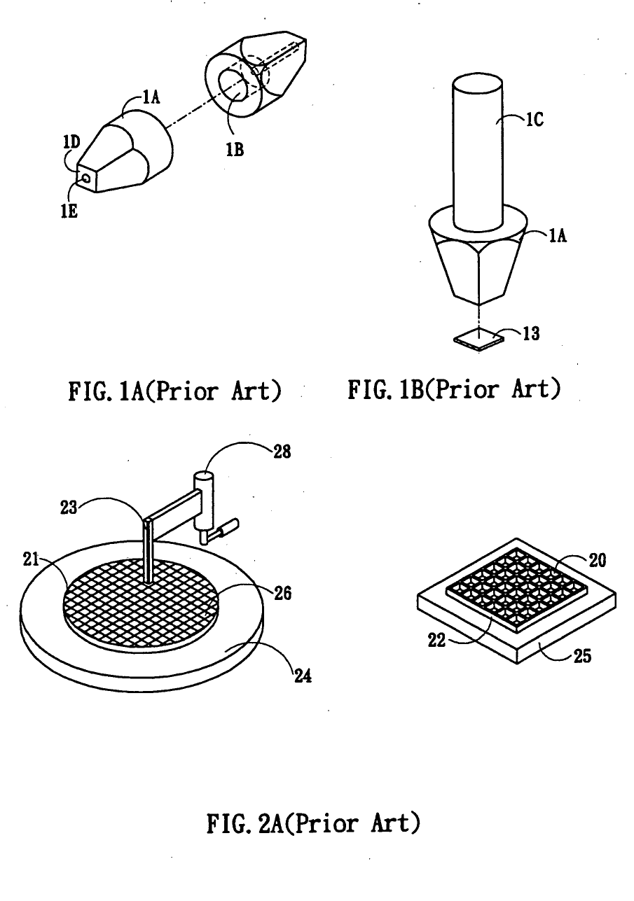

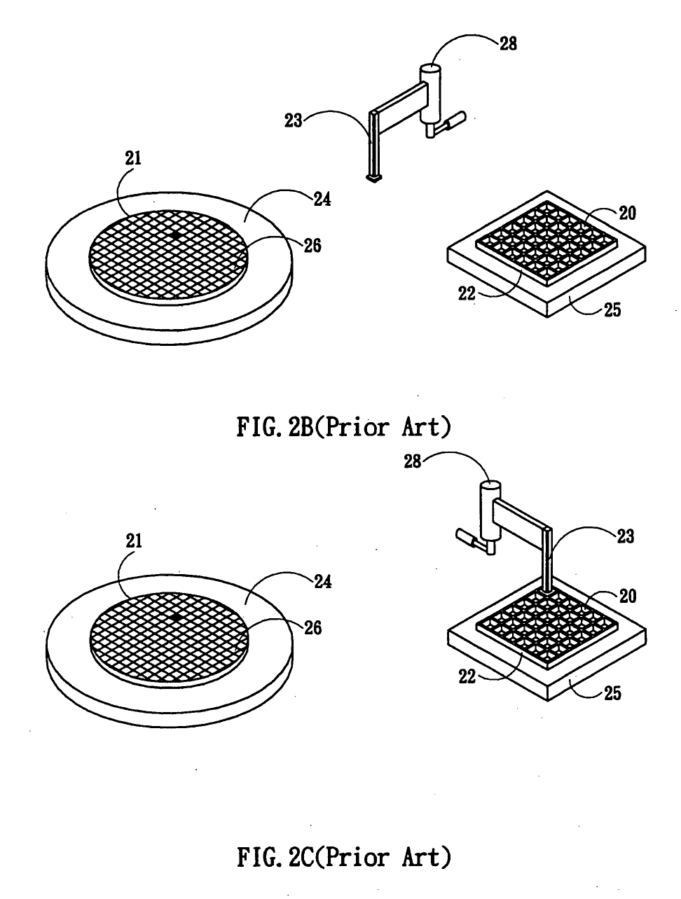

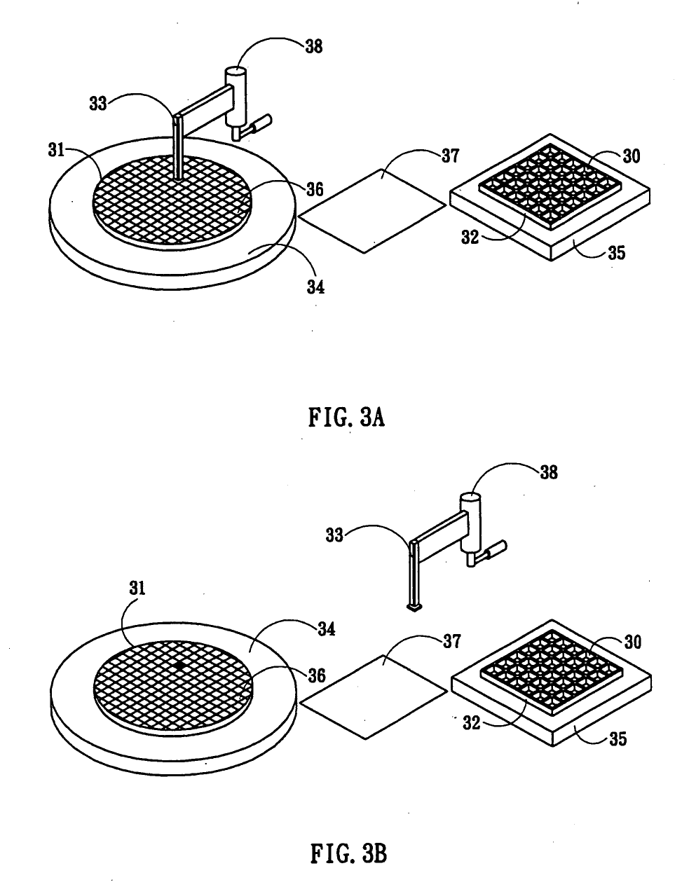

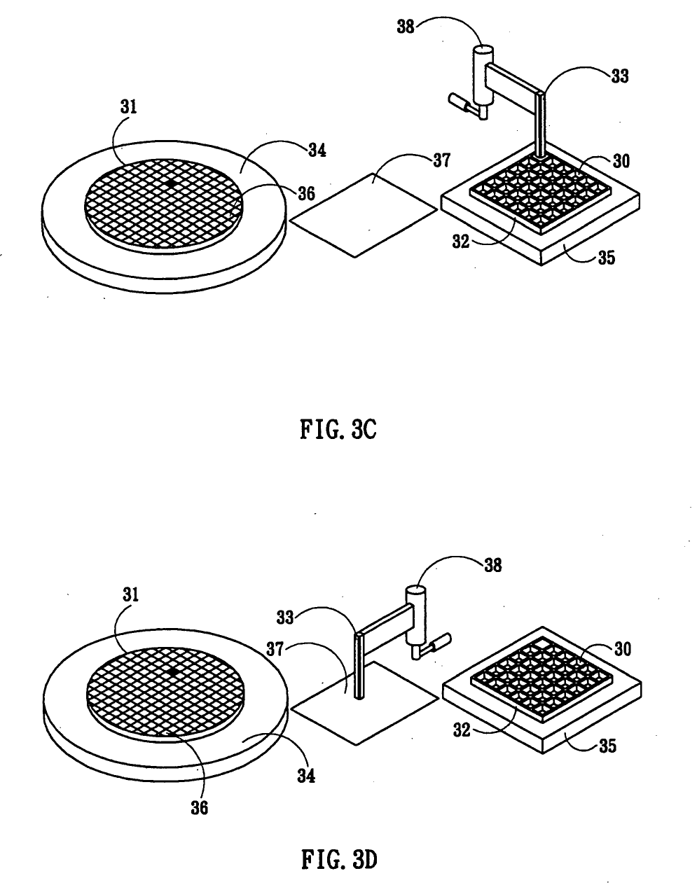

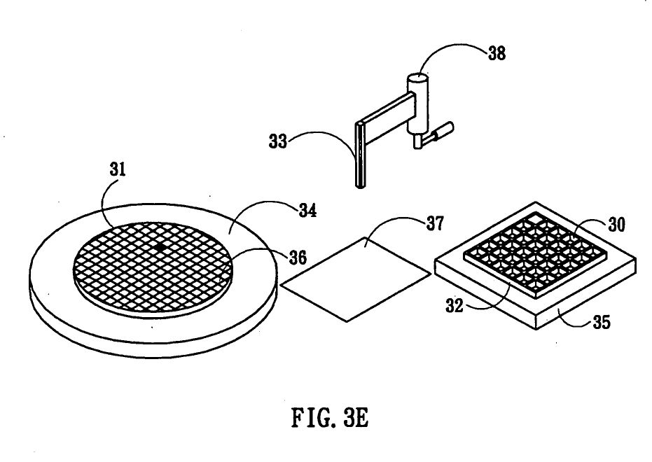

FIG. 3A to FIG. 3E illustrate the primary flow of automatically cleaning a pick-up head. According to the embodiment, wafer 31 is subjected to test and is then sawed or diced into dies or chips. Subsequently, the dies are transferred to a pick-and-place apparatus, where the dies are sorted into bins. Specifically, the sawed wafer 31 is placed on a supporting table 34 as shown in FIG. 3A. The pick-up head 33 moves, under the control of a robot 38, over the wafer 31, and then picks one die 36 to a receiving groove 30 of a tray (or bin) 32 according to the classification of that die 36. In the embodiment of the present invention, the pick-up head 33 has a vacuum sucker to its tip, and has a structure like that of FIG. 1A and FIG. 1B. Other type of sucker, however, could also be adapted well in the present invention. The tray 32 is disposed on a tray stand 35, which is part of the tray transportation module. It is appreciated that the pick-and-place apparatus and the tray transportation module contain further portions that are not drawn in the Figures for brevity. In addition to the mechanism discussed above, an area with an adhesive tape or glue-tape 37 is provided in the embodiment of the present invention. The adhesive tape 37 is disposed between the wafer 31 and the tray 32; but, however, the glue-tape 37 could be disposed at other location as well without diminishing the effect of the present invention. The glue-tape 37 of the present invention is preferable a glue-tape that does not leave residual glue or resin on an object after being contacted with that object. The glue-tape 37 could be tailor-made according to the required adhesivity, and more preferably, could be bought off the shelf. Those tapes commonly used in semiconductor industry, such as the blue/white tape used in backside grinding (also known as BG tape), the ultraviolet (UV) tape used in dicing wafers, or the tape automated bonding (TAB) tape could be adapted in the present invention for their beneficiary advantage that they substantially left no residual glue or resin on an object after being contacted with that object.

FIG. 3A shows the moment that a die 36 is picked by the pick-up head 33, and FIG. 3B shows that the robot 38 lifts the pick-up head 33, which carries the die 36 towards the tray 32. In FIG. 3C, the robot 38 lowers the pick-up head 33, and the pick-up head 33 releases the vacuum and disengages the die 36 unto the groove 30.

In the embodiment of present invention, the steps of FIG. 3A through 3C are performed several times (at least one time), which is determined beforehand, before going into the step of FIG. 3D. After the predetermined times have reached, the robot 38 moves the pick-up head 33 towards the area with the adhesive tape 37. As shown in FIG. 3D, the tip of the pick-up head 33 contacts the adhesive side of the glue-tape 37, under the control of the robot 38, for at least one time (for example four times). According to the embodiment of the present invention, the sawed wafer 31 results in particulate or contaminants, which are prone to be attached to the tip of the pick-up head 33. These particulate or contaminants are stick or attracted to the surface of the adhesive tape 37, thereby attaining the purpose of automatically cleaning the pick-up head 33. It is appreciated that the predetermined times mentioned above for moving the die towards the tray before going into the cleaning step is adjustable according to the requirement. Alternatively, the elapsed time before going into the cleaning step could be controlled within a predetermined interval, for example two hours. Further, the contact of the pick-up head 33 and the glue-tape 37 holds for a period, such as 0.1-3 seconds. The pressing force of the pick-up head 33 upon the glue-tape 37 is set, for example, at 0.1-10 newtons, which is usually determined according to how the elastics mechanism of the pick-up head could withstand such pressing force. During each cleaning step, the repeating times for which the pick-up head 33 contacts the glue-tape 37 is usually determined according to how the wafer is contaminated; in other words, a more contaminated wafer needs contacting the glue-tape for more times. Preferably, for each cleaning step or each contacting, the contacting position needs to be changed so that the pick-up head 33 will not be contaminated by the used glue-tape.

After each cleaning step, the robot 38 lifts the pick-up head 33 and moves towards the wafer 31 as shown in FIG. 3E. This ends the automatic cleaning process of the present embodiment. Afterwards, another cycle of the picking/placing/cleaning process starts at the step of FIG. 3A through FIG. 3E.

The embodiment discussed above is directed to the pick-and-place apparatus, and however, the present invention could be adapted to other semiconductor equipment which uses pick-up head to pick dies or wafers. For example, the pick-up head could be utilized to pick a die and attach it to a substrate in an integrated circuit (IC) packaging process. The automatic cleaning process proposed by the present invention prevents the pick-up head from being contaminated, thereby avoiding damage to the die.

As mentioned before, in the conventional process, the pick-and-place apparatus needs to be periodically shut down in order to clean or replace the pick-up head, thus preventing the particulate from contaminating the pick-up head. To the contrary, the pick-up head according to the present invention keeps itself clean without shutting down the pick-and-place apparatus. Therefore, the IC yield increases, and the equipment efficiency and productivity rise.

Although specific embodiments have been illustrated and described, it will be appreciated by those skilled in the art that various modifications may be made without departing from the scope of the present invention, which is intended to be limited solely by the appended claims.

What is claimed is:

1. A method of automatically cleaning a pick-up head, comprising:
picking up a semiconductor device by a pick-up head;
placing down the semiconductor device; and
contacting the pick-up head to an adhesive surface.

2. The method according to claim 1, wherein said pick-up head comprises a vacuum sucker.

3. The method according to claim 1, wherein said pick-up head is controlled by a robot.

4. The method according to claim 1, wherein said semiconductor device is a die of a wafer.

5. The method according to claim 4, wherein said die is placed down unto a groove of a tray.

6. The method according to claim 4, wherein said die is placed down onto a packaging substrate.

7. The method according to claim 1, wherein said adhesive surface is an adhesive surface of a glue-tape.

8. The method according to claim 7, wherein said adhesive surface of the glue-tape does not leave residue on the pick-up head after being contacted with the pick-up head.

9. The method according to claim 7, wherein said glue-tape comprises blue tape, white tape, ultraviolet tape, or tape automated bonding (TAB) tape.

10. The method according to claim 1, further comprising repeating the picking step and placing steps, followed by said contacting step.

11. Apparatus of automatically cleaning a pick-up head, comprising:
a pick-up head for picking up a semiconductor device;
a receiver configured for receiving the semiconductor device that is placed down; and
an adhesive surface adapted for being contacted with the pick-up head.

12. The apparatus according to claim 11, wherein said pick-up head comprises a vacuum sucker.

13. The apparatus according to claim 11, further comprising a robot for controlling said pick-up head.

14. The apparatus according to claim 11, wherein said semiconductor device is a die of a wafer.

15. The apparatus according to claim 14, wherein said receiver is a groove of a tray.

16. The apparatus according to claim 14, wherein said receiver is a packaging substrate.

17. The apparatus according to claim 11, wherein said adhesive surface is an adhesive surface of a glue-tape.

18. The apparatus according to claim 17, wherein said adhesive surface of the glue-tape does not leave residue on the pick-up head after being contacted with the pick-up head.

19. The apparatus according to claim 17, wherein said glue-tape comprises blue tape, white tape, ultraviolet tape, or tape automated bonding (TAB) tape.

20. The apparatus according to claim 11, further comprising a mechanism which repeats the picking step and placing steps, followed by said contacting step.
